(19) United States
(12) Patent Application Publication
(10) Pub. No.: US 2015/0235167 A1
(43) Pub. Date: Aug. 20, 2015

(54) METHOD AND SYSTEM FOR AUDITING OBJECTS, INVENTORY, AND COLLATERAL

(71) Applicants: Steven E. Wright, North Tonawanda, NY (US); John R. Armstrong, Clarence Center, NY (US)

(72) Inventors: Steven E. Wright, North Tonawanda, NY (US); John R. Armstrong, Clarence Center, NY (US)

(21) Appl. No.: 14/182,361

(22) Filed: Feb. 18, 2014

(51) Int. Cl. G06Q 10/08; H04B 1/3822; H04W 88/08; H04W 16/18; H04W 64/00

(52) U.S. Cl. CPC G06Q 10/087; H04W 16/18; H04W 64/00; H04W 88/08; H04B 1/3822

(57) ABSTRACT

A method for auditing object inventory disposed at an inventory storage location that comprises installing a wireless base station having a base station transponder at the inventory storage location. The base station transponder transmits a first radio signal out to a predetermined base station signal range boundary. Disposing at least one object having a wireless portable object transponder within the predetermined base station signal range boundary. The portable object transponder transmits a first object transponder radio signal out to predetermined transponder signal range boundary that encompasses the wireless base station. Upon detecting the first portable object transponder radio signal the base station transponder transmits a second base station radio signal causing the portable object transponder to transmit a second portable object transponder radio signal to the base station transponder that includes unique identifier data pertaining to the object being audited.

### FIELD OF INVENTION

This invention is directed to a method, system, and apparatus for allowing objects, expensive large equipment, or collateral disposed on or near a specific location, preferably, within a certain geographical boundary to be audited. The invention is also directed to a method, system, and apparatus for auditing vehicle inventory.

### BACKGROUND OF INVENTION

In a variety of settings, objects and large equipment are stored in the open for extended periods of time. For example, objects and large equipment may be placed on a large open land parcel or open land lot. Examples of such objects and large equipment includes, but is not limited to, automobiles, trucks, construction equipment, cargo containers, shipping containers, and the like. From an inventory standpoint, it is important to be able to monitor and ensure that the large equipment is still on the location that the large equipment was placed. Oftentimes, the equipment is owned, financed, or otherwise of interest to an individual or independent company that is not physically present at the location that the large equipment is being stored, and the large equipment serves as the collateral for a loan. That individual or company will need to periodically audit the large equipment to ensure that it is still located on the land parcel or land lot. Moreover, the individual or company will need to conduct audits quickly efficiently, and as cost effectively as possible.

Historically, audits of objects and large equipment have been done manually by an individual who goes onsite to ensure that each object or piece of equipment is present. This is very expensive and time consuming. Thus, recently there have been efforts at automating the process of auditing such inventory.

One method of automated auditing of large equipment inventory that has been used is the addition of a Radio Frequency Identification “RFID” chip to the large equipment. RFID chips are small and easily transported and thus can easily be removed from the large equipment, so tracking the large equipment in this manner merely ensures that the RFID chip is in the correct location, but does not ensure that the large equipment is in the correct location. In addition, RFID chip readers are needed to read the RFID chips, thus adding to expenses. Moreover, this method of automated auditing is easy to circumvent if a vehicle is not driven past the RFID reader.

Another method of automated auditing of large equipment inventory has been to add a Global Positioning System (hereinafter referred to as GPS) device connected to the large equipment. This allows the large equipment to be tracked to a specific location at any time ensuring that the equipment is where it belongs. While equipping the large equipment with a GPS tracking device is effective, it is a rather expensive means for tracking the large equipment.

Another method of automated auditing of large equipment inventory involves utilizing received signal strength indications in order to determine the precise location of a vehicle by triangulation. This solution requires the use of several devices to provide data points in order to determine where the vehicle is located. While this is effective, this method involves a great deal of complexity.

As outlined above, the current methods of auditing large equipment inventory are expensive, complex, and in some instances are easy to circumvent. Moreover, when auditing large equipment inventory, from the standpoint of the owner or independent company with an interest in the equipment (but is not physically present at the location that the large equipment is being stored) there is not a need to know the exact location of the large equipment. Rather, it is important to know that the large equipment is on a particular land parcel or land lot or within a certain geographical boundary.

Thus, there is a need to provide a method, system, and apparatus that allows for the determination of the general location of large equipment without the added expense and complexity of a GPS tracking device or a system.

### SUMMARY OF THE INVENTION

The present method and system provides a way for quickly and accurately auditing objects that are disposed within a geographic boundary, such as a parking lot. The objects can be virtually any objects that need to be audited. Examples of the types of objects that are capable of being audited include, but are not limited to, product inventory, collateral-type objects that serve as collateral to secure a loan, shipping containers, vehicles including cars and trucks, and boats.

The objects are disposed at a storage location and one or more wireless base station is installed at the storage location. The base station has a base station transponder. The base station is also connected to, for example, the Internet. The objects have portable object transponders and the base station transponder is capable of detecting and communicating with all the portable object transponders within the effective broadcast range of the base station. On either a continuous or periodic interval the base station transponder communicates through each of the portable object transponders within range and collects data. The base station then transmits identifying information data obtained from the portable object transponders and sends that information data to a web service. At the same time, the base station transmits its unique base station serial number to the web service so that the base station data is linked to that particular base station.

The effective range of the base station transponder and the portable object transponders and the network topology can be adjusted or manipulated by the user of the system, such that the coverage provided by both the base station transponder and the portable object transponders is suitable for the specific type of storage facility layout in which the objects are disposed.

The web services receive/accept data from the base station. This object data is utilized to generate a comprehensive history of when the objects were present or were not present at the storage location. As can be readily understood, access to the object data by, for example the owner of the collateral securing a loan, allows that owner to remotely audit its collateral at any desired time.

In one of the preferred embodiments, the above-described system and method for auditing vehicle inventory is adapted for use with a parking lot or parcel of land with vehicles on the lot. There is a base station that is physically located on the parking lot. Each vehicle has an on board diagnostic system (hereinafter referred to as OBD-II) and associated OBD-II port so that diagnostic vehicle information data can be readily accessed. Some of the diagnostic vehicle information data accessible by way of the OBD-II port is the vehicle identification number (hereinafter referred to as VIN) of that vehicle.

A transponder plug interface component is provided and it is adapted to be plugged directly into the OBD-II port. Thus, the transponder plug interface component has access to vehicle information data, including, but not limited to the VIN number of the vehicle. The portable object transponder is powered by the battery of the vehicle.

The base station has a base station transponder capable of sending and receiving signals, for example radio signals. It is pointed out that each of the portable object transponder and the base station transponder has a predetermined transmission power to limit the effective transmission distance of each. The base station transponder generates and sends or emits a first radio signal that is recognized by each of the portable object transponder. The portable object transponders are also capable of sending and receiving radio signals. This first radio signal is received by the portable object transponders and causes the portable object transponders to send a signal back to the base station transponder indicating the base station signal has been received.

The base station transponder then sends another signal to each portable object transponder requesting the VIN data of the vehicle to which it is connected. The base station receives the VIN number from each of the portable object transponders that are within the geographic range (for example a parking lot) covered by the first radio signal that was broadcasted by the base station transponder.

The base station gathers all the VIN numbers and sends them by way of Wi-Fi, cell signal, phone lines or other suitable technology to a management web server that may be owned by the owner of the vehicles, for example a bank. Data, such as the time the signal was sent data and data pertaining to which base station sent the VIN data is collected and stored. In addition, comparisons of the VIN data collected to VIN data of vehicles that are supposed to be on the lot are conducted, and the vehicle web server determines if VINs are missing, which indicates a vehicle is not on the lot. This data is then used to generate comprehensive reports of all VINs reported and any missing VINs, wherein a missing VIN indicates the vehicle may have been stolen or is out for a test drive.

In another preferred embodiment a wireless mesh network is utilized. The portable object transponders have built-in repeaters for regenerating radio signals. Some of the portable object transponders are in direct radio communication with a base station transponder located at a base station. The base station itself is at a fixed location within a geographical boundary and some of the portable object transponders are placed on or in objects that are within the same geographical boundary as the base station and that are within radio transmission range of the base station transponder. In particular, the portable object transponders and base station transponder have a preselected transmission power, thus, data sent from the portable object transponder can be effectively transmitted only a certain distance. At least one portable object transponder is placed on or in an object that is located within a preselected communication distance in relation to the base station transponder so that this portable object transponder is able to communicate wirelessly with the base station transponder. The portable object transponders are equipped with built-in repeaters. When a signal is sent by the base station transponder it is received by some of the portable object transponders that are within the transmission range of the base station and these portable object transponders re-broadcast or retransmit the radio signal received from the base station. Eventually, every object receives the signal sent by the base station transponder, even those that are out of transmission range of the original base station transmission. Then, when the portable object transponders respond to the base station transponder the responsive signals are repeated from the portable object transponders and are repeated over other the portable object transponders until the signal arrives at the base station transponder. This forms a wireless mesh network.

As a result of the wireless mesh network, some of the portable object transponders may be outside of the preselected transmission distance of the base station, but nonetheless are able to transmit data to the base station transponder by way of the other portable object transponders making up the wireless mesh network. In this embodiment, the portable object transponders include wireless mesh network communication systems that are configured such that the radio frequency signal attenuation of the device is manipulated by increasing or decreasing the transmission power or intentional interference of the radio frequency signal. When the interference of the signal is increased or the transmission power is decreased, the radio frequency signal attenuation is increased, thereby decreasing the effective communication distance. By using a plurality of portable object transponders with known communication distances and arranging them at certain distances from the base station and at certain distances from each other on a land parcel or parking lot, a predetermined transmission boundary can be established. Axiomatically, a geographical boundary can be selected first and then the base station and portable object transponders can be configured to provide communication coverage of the selected geographical boundary.

### BRIEF DESCRIPTION OF THE DRAWINGS

FIG. 1 is a schematic depicting the topography for a system for auditing object inventory.

FIG. 2 is a schematic further depicting the topography for the system for auditing object inventory depicted in FIG. 1.

FIG. 3 is a view depicting the flow of radio signals in the system for auditing object inventory.

FIG. 4 is a diagrammatic view of a portable object transponder.

FIG. 5 is an enlarged view of a portion of a cable lock having a portable object transponder.

FIG. 6 is a perspective view of a cable lock.

FIG. 7 is a perspective view of a cable lock having a portable object transponder securing a shipping container.

FIG. 8 is a schematic depicting the topography of a mesh network.

FIG. 9 is a schematic further depicting the topography of the mesh network of FIG. 8.

### DETAILED DESCRIPTION OF THE INVENTION

As used herein the phrase collateral storage location 11 includes, but is not limited to the following: vehicle parking lots, land parcels, passenger vehicle dealership parking lots, vehicle rental parking lots, recreational vehicle parking lots, vehicle repair parking lots, truck rental facility parking lots, aircraft fields, motorcycle parking lots, bus parking lots, tractor trailer parking lots, train storage parking lots, boat storage lots, and combination parking lots which encompass a parking lots that contains different types of vehicles. For example, a combination parking lot may contain motorcycles, rental trucks, and boats.

As used herein and in the appended claims, the term vehicle includes, but is not limited to: passenger vehicles, rental vehicles, rental trucks, buses, boats, motorcycles, boats, airplanes, bicycles, and tractor trailer trucks.

Object Auditing

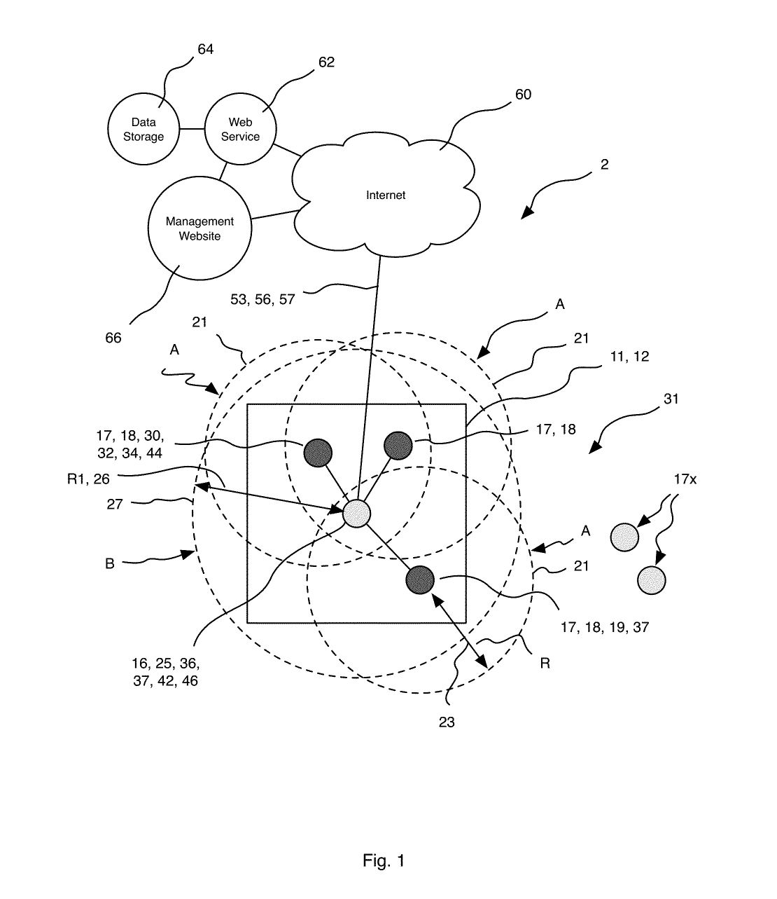

In a first embodiment, FIG. 1 shows a schematic depicting a system for auditing object inventory 2 at an inventory or collateral storage location 11. In FIG. 1 the inventory or collateral storage location 11 is in the form of a land parcel 12 having a generally rectangular shape. A wireless base station 16 is located on the land parcel 12 and the wireless base station 16 is connected to the Internet 60. Objects 17 (sometimes referred to herein as inventory) are located on the land parcel 12, and each object 17 has attached to it a portable object transponder 18, and the portable object transponder 18 is wireless. Three objects 17 are shown, but it is to be understood that there can be more or less than three objects 17 in other preferred embodiments. Each of the portable object transponders 18 has a predetermined signal transmission power and generates a radio signal that has a predetermined effective signal range, and wherein the predetermined effective signal range is effective out to a predetermined transponder signal range boundary 21. In FIG. 1, the predetermined transponder signal range boundaries 21 for each of the portable object transponders 18 are circle-shaped and are shown as dashed circles designated A. It is pointed out that the predetermined transponder signal range boundaries 21 overlap one another. By adjusting the transmission power of the portable object transponders 18, an effective communication distance 23 is established for each of the portable object transponders 18. The effective communication distance 23 is the distance from the portable object transponders 18 to the predetermined transponder signal range boundary 21. The effective communication distance 23 is equal to the radius, designated R, of the predetermined transponder signal range boundary 21, as shown. Each of the portable object transponders 18 is capable of storing and transmitting object data 56. Moreover, it is possible that the communication distance 23 of one portable transponder 18 is different than the communication distance 23 of another portable transponder 18 by varying the power supplied to the portable transponder 18. Thus, the communication distance boundary 23 can be adjusted and in one of the preferred embodiments can be about 0.01 miles, but could be more or less in other preferred embodiments, for example 0.1 miles or 0.4 miles.

The base station 16 has a base station transponder 25 having a predetermined base station signal transmission power and that generates a base station radio signal having a predetermined effective base station signal range. In particular, the base station transponder 25 transmits out to a predetermined base station signal range boundary 27 that encompasses the predetermined effective base station signal range. The predetermined base station signal range boundary 27 of the base station transponder 25 is shown as a dashed circle indicated B in FIG. 1. As shown, the base station transponder 25 has an effective base station communication distance 26 that is the distance from the base station transponder 25 to the predetermined base station signal range boundary 27, and the effective base station communication distance 26 is equal to the radius, designated R1, of the predetermined base station signal range boundary 27. In one of the preferred embodiments the effective base station communication distance 26 (R1) is greater than the effect communication distance 23 (R). It is pointed out that the base signal range boundary 27 overlaps all the predetermined signal range boundaries 21, thus allowing the base station transponder 25 to communicate with all the portable object transponders 18. What has been described above may generally be referred to as a hub and spoke network topology 31.

By adjusting the base station signal transmission power, the extent of range of the predetermined base station signal range boundary 27 can thus be adjusted to cover the land parcel 12 and the objects 17 disposed on the land parcel 12. Outside objects 17x that are disposed outside of the predetermined base station signal range boundary 27 will not be audited, thus reducing or eliminating the possibility of collecting data from outside objects 17x that may be equipped with outside portable object transponders.

As shown in FIG. 3, each portable object transponder 18 has a programmable object microcontroller 30 having an object transponder processor 32, a portable object transponder memory component 34, a wireless communication system component 37 and associated circuitry disposed on a circuit board. For the sake of clarity only one portable object transponder 18 has been so numbered in FIG. 3, it being understood all the portable object transponders 18 are the same. Similarly, the base station transponder 25 has a programmable base station transponder processor 36 having a base station processor 37, a base station transponder memory component 42, and a wireless communication system 43. The construction, operation, programming and use of transponders, including wireless communication components for use in connection with transponders, is well known to those having ordinary skill in the art and are therefore they are not described in greater detail herein. The portable object transponders 18 have internal clocks 44 and are programmed to enable the internal clocks 44 to synchronize with an internal base station clock 46 associated with the base station transponder 25. The portable object transponders 18 internal clocks 44 are programmable to wake up or activate at scheduled time intervals and wait for the first radio signal 48 from the base station transponder 25. The portable object transponders 18 are programmed to remain active for a predetermined number of minutes, after which time expires the portable object transponders 18 de-activate or become inactive. This extends the battery life of the battery powering the portable object transponders 18 and base station transponder 25.

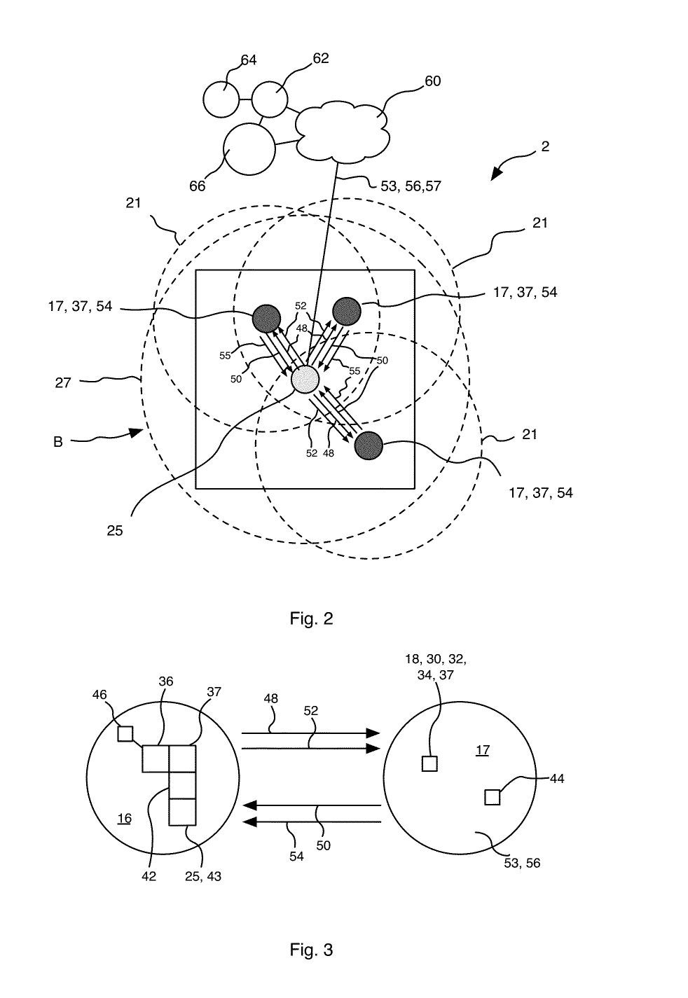

FIG. 2 is the same as FIG. 1, but many reference numerals and several components have not been shown for the sake of clarity. When auditing is conducted the following method is utilized. First, the base station transponder 25 sends a first base station radio signal 48 to all the portable object transponders 18 within the predetermined base station signal range boundary 27. For the sake of clarity, FIG. 3 details the first base station radio signal 48 and other signals to be described presently. The first base station radio signal 48 is for activating all the portable object transponders 18 within the predetermined base station signal range boundary 27. Each of the portable object transponders 18 that receive the first base station radio signal 48 respond with a first portable object transponder radio signal 50 that is detected by the base station transponder 25. It is pointed out that only the portable object transponders 18 within the predetermined base station signal range boundary 27 will be capable of receiving the first base station radio signal.

Next, the base station transponder 25 sends out a second base station radio signal 52. Each of the portable object transponders 18 has unique identifier data 53 (FIG. 3), for example a unique serial number. In response to the second base station radio signal 52 each of the portable object transponders 18 transmits a second portable object transponder radio signal 54 to the base station transponder 25 that includes the unique identifier data 53. In this manner, the base station transponder 25 acquires the unique identification data 53 of each object 17 physically disposed within the predetermined base station signal range boundary 27. It is pointed out that the portable object transponder memory component 34 of the portable object transponder 18 can store not only the unique identification data 53 of each object 17, but also object data 56 pertaining to the object 17. Examples of object data 56 include, but are not limited to, object serial number, object product name, object country of origin, object ownership, time and date the object data was received by the base station transponder 25. As shown in FIG. 1, the land parcel 12 is completely within the predetermined base station signal range boundary 27.

The base station transponder 25 takes the unique identification data 53 and other object data 56 received from all the portable object transponders 18 and transmits it over Wi-Fi, Cellular, Ethernet, copper phone lines (commonly designated 57) or other transmission technologies to the Internet 60. From the Internet 60 the data is accessed by an auditor web service 62 and the unique identification data 53 of each object 17 and object data 56 pertaining to the object 17 is saved in an auditor database 64. There is an auditor management website 66 that can access and monitor all of the incoming unique identification data 53 and object data 56 pertaining to the objects 17. It is noted that the system for and method for auditing objects inventory 2 allows for objects 17 to be monitored remotely and there is no need for a person to physically look and check if the object 17 is or is not on the land parcel 12. In addition, if an object 17 is missing in that no identification data 53 for that object 17 is received, then suitable action can be immediately taken to determine why the object 17 is missing and an investigation can be commenced.

The above auditing process repeats at predetermined time intervals and the length between the audits is dependent of the interval time programmed into the portable object transponders 18.

In another preferred embodiment, the topology of the land parcel 12 may be such that two or more base stations 16 are called for to cover the land parcel 12. In such an embodiment the second base station 16 would function and operate the same as the base station 16 described above.

A method for auditing inventory is thus provided by the above-described system for auditing object inventory 2.

Vehicle Auditing

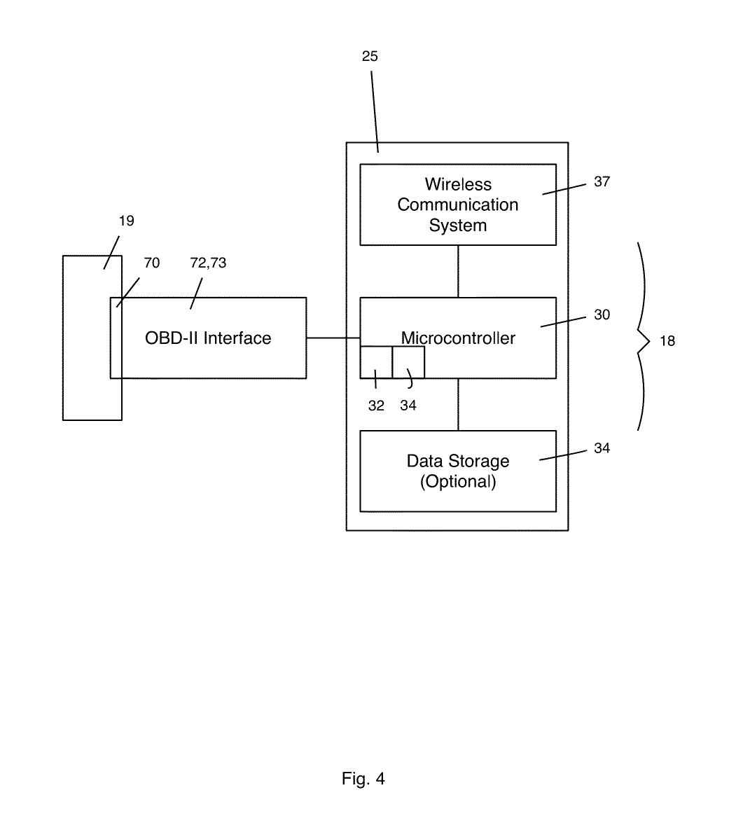

The above-described system for auditing object inventory 2 can be used in connection with auditing vehicle inventory, in other words, the objects 17 are passenger vehicles 19. Thus, in FIG. 1, the objects 17 are understood to be vehicles 19 as indicated by the dashed reference line in FIG. 1. FIG. 4 shows a portion of the vehicle 19. For example, a financial institution has lent money to the passenger vehicle dealership so that the passenger vehicle dealership is able to purchase the passenger vehicles 19. In exchange for this loan, the financial institution will take a security interest in collateral, which in this case are the actual passenger vehicles 19 on the land parcel 12 which in this case is embodied as a vehicle parking lot. Thus, the financial institution will use the system for auditing object inventory 2 in order to ensure that the collateral (the passenger vehicles 19) are all within base station signal range boundary.

In particular, each of the vehicles 19 has an OBD-II port 70 and the portable object transponder 18 includes a transponder plug interface component 72 that is adapted to be plugged into the OBD-II port 70 of the vehicle 19. The transponder plug interface component 72 has a microchip 73. The transponder plug interface component 72 allows the portable object transponder 18 to directly retrieve information and data pertaining to the vehicle 19, for example the vehicle identification number (hereinafter VIN). The VIN serves as the above-described unique identifier data 53. In this embodiment the portable object transponder 18 draws power from the battery of the vehicle 19.

After the transponder plug interface components 72 have been plugged into the OBD-II port 70 the portable object transponders will activate at predetermined time intervals as described above. The base station transponder 25 will send the first base station radio signal 48 and activates all the portable object transponders 18. Each of the portable object transponders 18 that receive the first base station radio signal 48 respond with a first portable object transponder radio signal 50 that is detected by the base station transponder 25. Next, the base station transponder 25 sends out a second base station radio signal 52, and each of the portable object transponders 18 responds by sending back the VIN data. The VIN data is subsequently processed in the same manner as previously described and makes it available to the auditor web service 62 that may be the owned by the financial institution, such that the financial institution will have a constant flow of data pertaining to its collateral at regular intervals, without having to physically conduct an audit in the dealership parking lot.

If all of the passenger vehicles 19 are not present, then the financial institution, that controls the management website 66, will be alerted to this and will take further steps to determine where the passenger vehicle(s) 19 is/(are) located.

It is pointed out that the vehicle 19 may have the portable object transponder 18 installed in it at the manufacturing facility or at a dealership lot and that in other embodiments the transponder plug interface component 72 of the portable object transponder 18 may be plugged into ports other than a port associated with a OBD-II system.

When setting up the system for the present invention, the financial institution and/or the passenger vehicle dealership will determine a boundary within which to place the passenger vehicles. A base station will be located within the boundary. Each passenger vehicle will be fitted with portable object transponders, wherein the portable object transponders will contain wireless communication systems that have predetermined communication distances. The passenger vehicles containing the portable object transponders will be located within communication distance of the base station and/or another passenger vehicle with a portable object transponder, such that the portable object transponders can transmit information to the base station.

Once the passenger vehicles containing portable object transponders are arranged within the boundary, the portable object transponders and the base station are powered and synchronized to each other.

The portable object transponders are programmed to sleep and to wake a preset number of minutes before every hour or at another preset time and to seek other portable object transponders to join and to become available for other portable object transponders. The portable object transponders are programmed to wait for the base station to become available and to report information to the base station once the base station is available. The base station is programmed to collect the information from all of the portable object transponders and relay the information to a database or computer located either on site or off site. The portable object transponders and base station are programmed to sleep after information has been reported and relayed.

General Assets Inventory Auditing

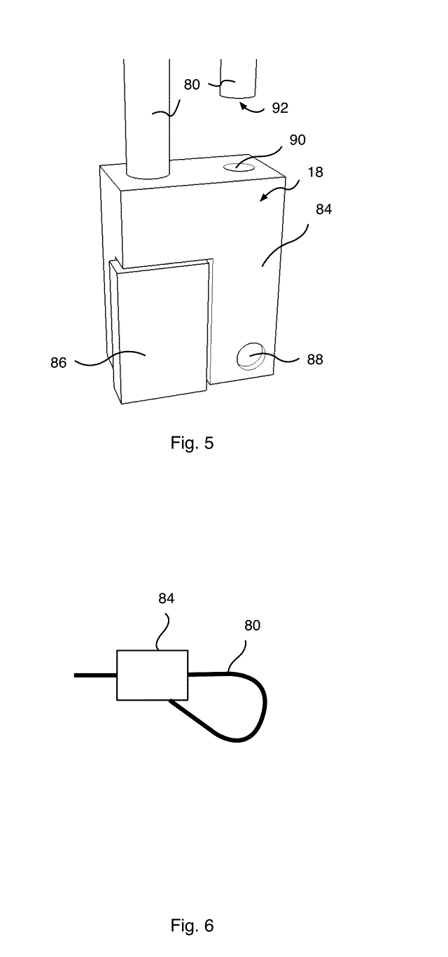

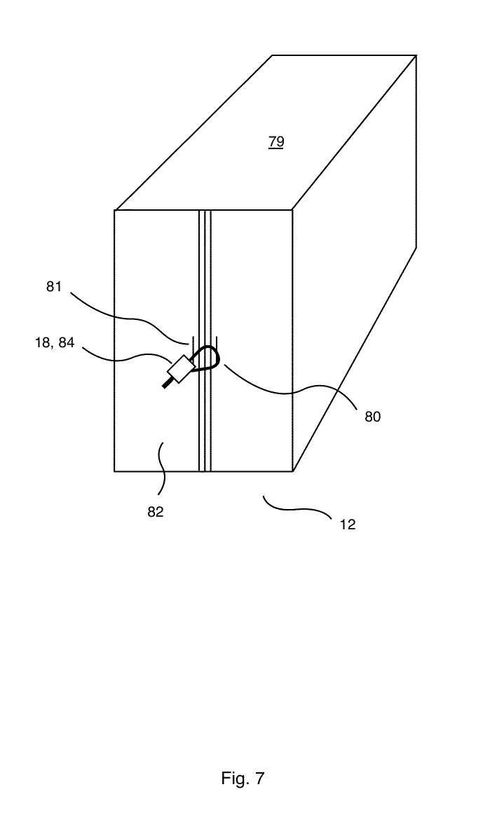

It is pointed out that the system for auditing object inventory 2 can also be used in connection with auditing virtually any physical asset. For example, shown in FIGS. 5-7 is a locking cable 80 for securing objects 17 that are in the form of, for example, a shipping container or a cargo box 79 that is disposed in on a land parcel 12 or other collateral storage location. In this embodiment the locking cable 80 is strung through the handles 81 of a shipping container 82 and secured thereon with a lock 84 that is connected to the locking cable 80. The lock 84 includes a battery 86 and a portable object transponder 18, and defines a keyhole opening 88 and a cable receiving opening 90. One end of the cable 92 can be fitted in the cable receiving opening 90 and the lock 84 can be locked with a key 94 thus securing the cable 80.

The portable object transponder 18 operates with a base station transponder 25 (not shown) located at the base station 16 (not shown) in the manner previously described in connection with the first embodiment. The portable object transponder 18 reports unique identifier data 53, for example a serial number to the base station transponder 25. Thus, the owner of the shipping container 79 can audit whether or not the cargo box 79 is or is not on the land parcel 12 or other collateral storage location in the same manner as described above.

Mesh Network

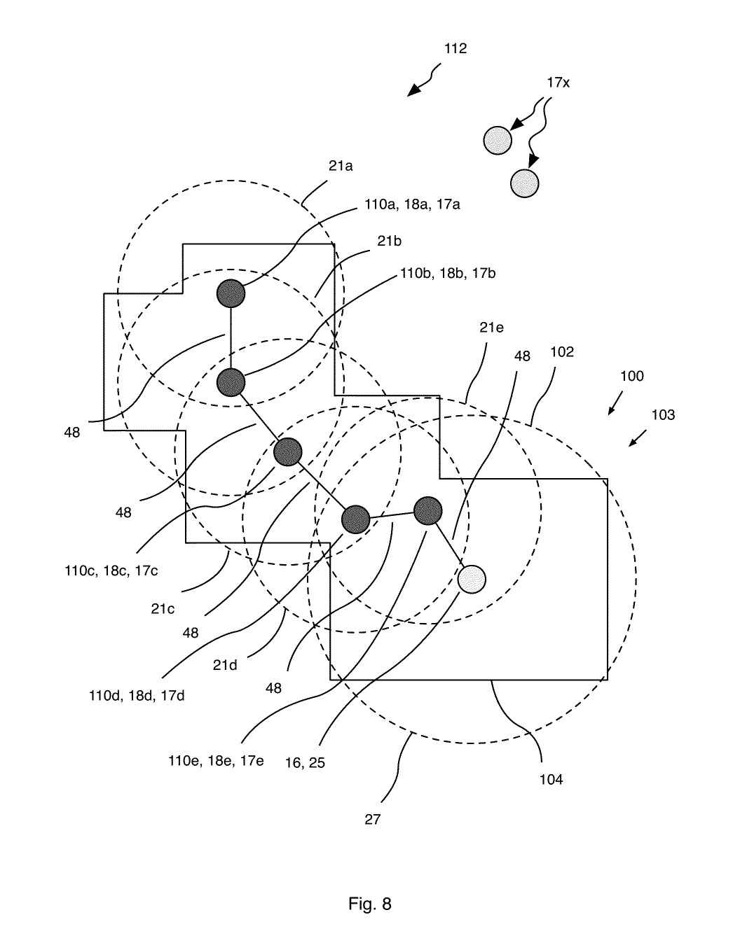

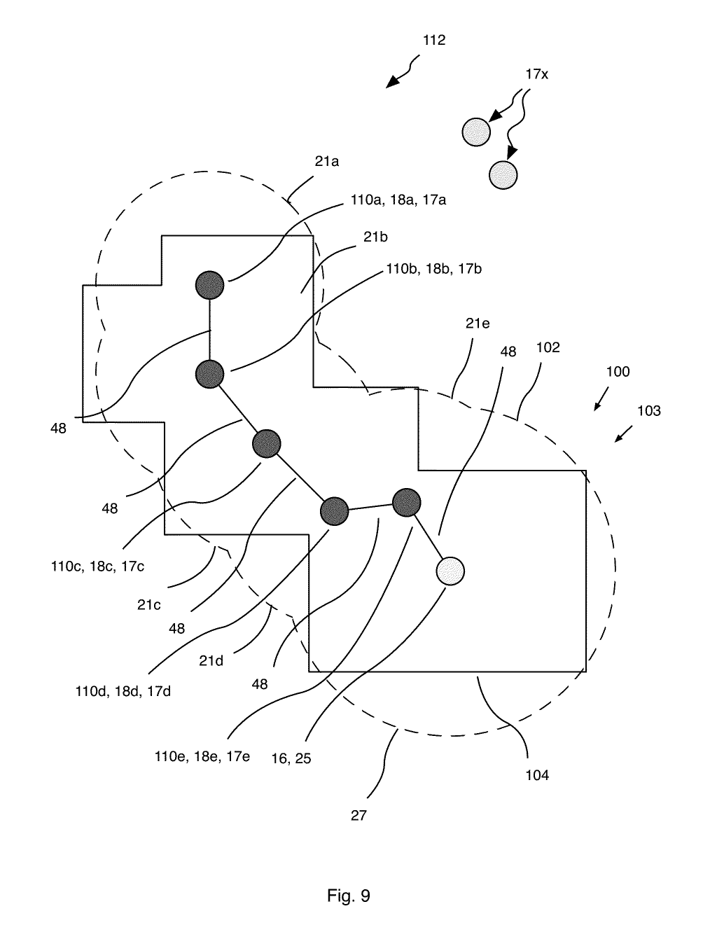

In another preferred embodiment shown in FIGS. 8 and 9, there is a mesh network topology 100. In instances where the collateral storage location 11 is not in the form of a convenient rectangular shape, but rather is misshapen or has an irregular shape, then a wireless mesh network 102 is provided that creates a wireless mesh network communication system 103. Such misshapen collateral storage location 104 (shown in solid line in FIGS. 8 and 9) has first object 17a with a first portable object transponder 18a, second object 17b with a second portable object transponder 18b, a third object 17c with a third portable object transponder 18c, a fourth object 17d with a fourth portable object transponder 18d, and a fifth object 17e with a fifth portable object transponder 18e. There is also a base station transponder 25 located at the base station 16 as previously described. The first, second, third, fourth and fifth objects 17a, 17b, 17c, 17d, and 17e are vehicles in one of the preferred embodiments.

In addition, the first, second, third, fourth and fifth portable object transponders 18a, 18b, 18c, 18d and 18e each has a predetermined effective signal range that is effective out to a predetermined transponder signal range boundary 21a, 21b, 21c, 21d and 21e, respectively. As previously described, the base station transponder 25 transmits out to a predetermined base station signal range boundary 27, and as shown its coverage encompasses the fourth and fifth objects 17d, 17e and forth and fifth portable object transponders 18d, 18e. There are also outside objects 17x that are outside the effective range of the first, second, third, fourth, and fifth portable object transponders 18a, 18b, 18c, 18d and 18e, and the base station transponder 25, and these outside objects 17x will not be audited.

As shown, the first, second, and third objects 17a, 17b, 17c are not within the predetermined base station signal range boundary 27 of the base station 16. Thus, the first, second, third, fourth, and fifth portable object transponders 18a, 18b, 18c, 18d and 18e are each equipped with built-in first, second, third, fourth and fifth radio repeaters 110a, 110b, 110c, 110d and 110e, respectively. The first, second, third, fourth and fifth radio repeaters 110a, 110b, 110c, 110d and 110e are combination radio receivers and radio transmitters that receive signals and retransmit the radio signals. By use of the first, second, third, fourth and fifth radio repeaters 110a, 110b, 110c, 110d and 110e a mesh network topology 112 is created. The use, operation and functionality of radio repeaters are are well known in the art and therefore are not described in greater detail herein.

Thus, when the base station transponder 25 sends a first base station radio signal 48 to all the portable object transponders 18 the fourth and fifth portable object transponders 18c and 18d receive the signal. The fourth and fifth radio repeaters 110d and 110e retransmit the first base station signal 48, and the first base station signal 48 is transmitted to the third radio repeater 110c, and the third radio repeater 110c retransmits the first base station radio signal 48. This process repeats until the first base station signal 48 is received by the first radio repeater 110a as shown in FIG. 9. In this manner all of the first, second, third, fourth, and fifth portable object transponders 18a, 18b, 18c, 18d and 18e receive the first base station signal 48. Then, each of the first, second, third, fourth, and fifth portable object transponders 18a, 18b, 18c, 18d and 18e respond with first portable object transponder radio signals 50 (shown as arrows in FIG. 9). Of course, the first portable object transponder radio signals 50 transmitted by the first, second, and third portable object transponders 18a, 18b, 18c are repeated by the built-in radio repeaters so that these signals eventually are received by the base station transponder 25. The first portable object transponder radio signal 50 is the same as previously described in connection with the first embodiment.

Then, the base station transponder 25 sends out a second base station radio signal 52 in the manner previously described and the second base station radio signal 52 is retransmitted by the first, second, third, fourth and fifth built-in radio repeaters 110a, 110b, 110c, 110d and 110e until it is received by the first, second, third, fourth, and fifth portable object transponders 18a, 18b, 18c, 18d and 18e. Each of the portable object transponders 18a, 18b, 18c, 18d and 18e has unique identifier data 53 as previously described. In response to the second base station radio signal 52 each of first, second, third, fourth and fifth portable object transponders 18 transmits a second portable object transponder radio signal 54 to the base station transponder 25 that includes the unique identifier data 53. In this manner, the base station transponder 25 acquires the unique identification data 53 of each object 17a, 17b, 17c, 17d and 17e physically disposed within the misshapen collateral storage location 104. As previously described, the base station transponder 25 takes the unique identification data 53 and other object data 56 received from the first, second, third, forth and fifth portable object transponders 18a, 18b, 18c, 18d and 18e and transmits it over Wi-Fi, Cellular, Ethernet, copper phone lines (commonly designated 57) and other transmission technologies to the Internet 60 as previously described.

In the above described embodiments the microcontroller 30 is an ATmega 328P (or any other suitable microcontroller), which is well known to those having ordinary skill in the art and is made by Atmel Corporation in San Jose, Calif. and is commercially available online. The microcontroller 30 runs customized software programmed to include a clock 44 and functions to synchronize the portable object transponder 18 with a base station 16 such that the base station 16 and portable object transponder 18 are programmed to power on continuously or at predetermined intervals. The software also functions such that the portable object transponder 18 responds to a prompt from the base station 16, wherein the base station 16 asks for a report from the portable object transponder 18. The software functions such that the portable object transponder 18 requests and receives information (preferably VIN and other OBD-II data) from the OBD-II 70 and the portable object transponder 18 then reports the information to the base station 16, and the software controls the radio repeaters 110a, 110b, 110c, 110d and 110e. Programming microcontrollers is well known in the art and therefore not described herein in greater detail.

The base station 16 contains a clock 44 and is capable of being synchronized with the portable object transponder 18 devices and the base station 16 is a ConnectPort® X3/X3 H. The ConnectPort® X3/X3 H is well known to those having ordinary skill in the art and is commercially available from Digi International® Inc. having an address of 11001 Bren Road E., Minnetonka, Minn. 55343.

In another embodiment, the microchip 73 that interfaces with the coupling connection component or transponder plug interface component 72 is the STN 1110 or the ELM327 or a suitably similar microchip. The STN 1110 is well known to those of ordinary skill in the art and is commercially available from OBD Solutions having an address of 1819 W. Rose Garden Ln, Phoenix, Ariz. 85027. The ELM327 is well known to those of ordinary skill in the art and is commercially available from Elm Electronics in Toronto, Canada. 1819

In another embodiment, the wireless mesh network 102 and associated wireless mesh network communication system 103 is an Xbee Pro S2B. This component is well known in the art and is available commercially from Digi International® Inc. having an address of 11001 Bren Road E., Minnetonka, Minn. 55343. The wireless mesh network 102 communication system contains internal antennae and directly or indirectly communicates with the base station 16. The wireless mesh network 102 communication system can be customized such that the predetermined base station signal range boundary 27 can be preselected by increasing or decreasing radio frequency signal attenuation. Radio frequency signal attenuation is the gradual loss in intensity of the radio frequency signal due to interference. The more interference there is, the more radio signal attenuation there is and thus, the less distance the radio frequency signal is able to travel. Interference may be created by decreasing power to the wireless mesh network communication system 103, changing signal absorption, changing signal reflection, and/or insulation. In one of the preferred embodiments the wireless mesh network uses 802.15.4 wireless technology.

Although the method, system, and apparatus of auditing objects, inventory and vehicle inventory has been explained in relation to its preferred embodiments, it is to be understood that many other possible modifications and variations can be made without departing from the spirit and scope of the invention as herein described.

What is claimed is:

1. A method for auditing object inventory disposed at an inventory storage location, the method comprising the steps of:
installing a wireless base station having a base station transponder at the inventory storage location, and wherein the base station transponder transmits a first radio signal out to a predetermined base station signal range boundary;
disposing at least one object having a wireless portable object transponder within the predetermined base station signal range boundary, and wherein the portable object transponder transmits a first portable object transponder radio signal out to predetermined transponder signal range boundary which encompasses the wireless base station; and,
wherein upon detecting the first portable object transponder radio signal the base station transponder transmits a second base station radio signal causing the portable object transponder to transmit a second portable object transponder radio signal to the base station transponder, and wherein the second portable object transponder radio signal includes unique identifier data pertaining to the object such that the object can be audited.

2. The method for auditing object inventory according to claim 1 further including providing communicating the unique identifier data over at least one of the following: Wi-Fi, Cellular, Ethernet, or copper phone lines to the Internet, and providing an auditor web service having an auditor database for storing the unique identifier data.

3. The method for auditing object inventory according to claim 2 further including conducting an audit of unique identifier data and determining whether or not the object is or is not present at the inventory storage location based on the unique identifier data.

4. The method for auditing object inventory according to claim 2 further including providing the base station transponder with an internal transponder clock and programming the base station transponder such that the transponder activates at predetermined time intervals in order to transmit the first radio signal.

5. The method for auditing object inventory according to claim 4 further including providing the portable object transponder with an internal clock and programming the portable object transponder, and providing an internal base station clock associated with the base station transponder, and programming the base station transponder and base station transponder such that the internal clock and the internal base station clock are synchronized with one another, such that the portable object transponder and the base station transponder activate at the same predetermined time to allow the first radio signal transmitted to be received by an active portable object transponder.

6. The method for auditing object inventory according to claim 1 further including providing the object to be a vehicle and providing a transponder plug interface component operatively connected to the portable object transponder and wherein the transponder plug interface component is adapted to be plugged into an OBD-II port of the vehicle.

7. The method for auditing object inventory according to claim 6 further including providing the unique identifier data to be vehicle identification data and providing the inventory storage location to be a vehicle dealership lot such that the vehicles on the vehicle dealership lot are capable of being audited.

8. A method for auditing object inventory disposed at an inventory storage location, the method comprising the steps of:
installing a wireless base station having a base station transponder at the inventory storage location, and wherein the base station transponder transmits a first radio signal out to a predetermined base station signal range boundary;
disposing a first object having a first wireless portable object transponder within the predetermined base station signal range boundary;
disposing a second object having second wireless portable object transponder outside of the predetermined base station signal range boundary;
wherein the first wireless portable object transponder transmits a first portable object transponder radio signal out to a predetermined transponder signal range boundary that encompasses the wireless base station and the second object,
wherein the second wireless portable object transponder of the second object transmits a second portable object transponder radio signal out to a predetermined transponder signal range boundary that encompasses the first object but not the base station transponder;
providing the first and second wireless portable object transponders with first and second built-in radio repeaters such that the first radio signal from the base station transponder is transmitted to the first wireless portable object transponder and the first portable object transponder retransmits the first radio signal from the base station to the second wireless portable object transponder; and,
wherein upon detecting the first portable object transponder radio signal the base station transponder transmits a second base station radio signal causing the first portable object transponder to transmit the second base station radio signal to the second wireless portable object transponder.

9. The method for auditing object inventory 8 further wherein in response to the second base station radio station the first wireless portable object transponder transmits unique identifier data pertaining to the first object to the base station transponder, and wherein the second wireless portable object transponder transmits unique identifier data pertaining to the second object to the first wireless portable object transponder monitoring device that retransmits the unique identifier data pertaining to the second object to the base station transponder.

10. The method for auditing object inventory according to claim 9 further including providing the first and second object to be vehicles and providing each of the first and second wireless portable object transponders with transponder plug interface component that are each adapted to be adapted to be plugged into and OBD-II port of the vehicle.

11. The method for auditing object inventory according to claim 10 further including providing the unique identifier data pertaining to each of the first and second objects to be vehicle identification data and providing the inventory storage location to be a vehicle dealership lot such that the vehicles on the vehicle dealership lot are capable of being audited.

12. A system for auditing object inventory disposed at an inventory storage location, the system comprising:
a wireless base station having a base station transponder disposed at the inventory storage location, and wherein the base station transponder is capable of transmitting a first radio signal out to a predetermined base station signal range boundary;
at least one object having a wireless portable object transponder disposed within the predetermined base station signal range boundary, and wherein the portable object transponder is capable of transmitting a first portable object transponder radio signal out to a predetermined transponder signal range boundary which encompasses the wireless base station; and,
wherein upon detecting the first portable object transponder radio signal the base station transponder is capable of transmitting a second base station radio signal causing the portable object transponder to transmit a second portable object transponder radio signal to the base station transponder, and wherein the second portable object transponder radio signal includes unique identifier data pertaining to the object such that the object can be audited.

13. The system for auditing object inventory according to claim 12 further including Wi-Fi, Cellular, Ethernet, or copper phone communication services and communicating the unique identifier data over at least one of the communication services to the Internet and wherein an auditor web service having an auditor database is capable of retrieving and storing the unique identifier data from the Internet.

14. The system for auditing object inventory according to claim 12 further including wherein the base station transponder has an internal transponder clock that is preprogrammed to activate at predetermined time intervals in order to transmit the first radio signal.

15. The system for auditing object inventory according to claim 12 wherein the object is a vehicle and a transponder plug interface component is operatively connected to the portable object transponder and wherein the transponder plug interface component is adapted to be plugged into an OBD-II port of the vehicle.

16. The system for auditing object inventory according to claim 15 wherein the unique identifier data is in the form of vehicle identification data and wherein the inventory storage location is a vehicle dealership lot such that the vehicles on the vehicle dealership lot are capable of being audited.
